(19) United States
(12) Patent Application Publication
(10) Pub. No.: US 2009/0002147 A1
(43) Pub. Date: Jan. 1, 2009

(54) METHOD FOR SAFE OPERATION OF MOBILE PHONE IN A CAR ENVIRONMENT

(75) Inventors: L. Scott Bloebaum, Cary, NC (US); William O. Camp, JR., Chapel Hill, NC (US); Kenneth M. Bednasz, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/210,473

(22) Filed: Sep. 15, 2008

Related U.S. Application Data
(63) Continuation-in-part of application No. 11/468,336, filed on Aug. 30, 2006.

(51) Int. Cl. B60Q 1/54; H04B 1/38

(52) U.S. Cl. 340/466; 455/565

(57) ABSTRACT

A method of operating electronic equipment, wherein said electronic equipment utilizes a wireless signal to communicate, includes determining if the electronic equipment is operated within a moving vehicle based on a characteristic of the wireless signal and inhibiting operation of the electronic equipment if the electronic equipment is in a moving vehicle. Also provided is a method of operating electronic devices, wherein it is determined if a first electronic device is in communication with a second electronic device while the first electronic device is in a moving vehicle. A notification is provided on the second electronic device corresponding to the determination.

### RELATED APPLICATION DATA

This application is a continuation-in-part of U.S. application Ser. No. 11/468,336 filed on Aug. 30, 2006, the entire contents of which is incorporated herein by reference in its entirety.

### TECHNICAL FIELD OF THE INVENTION

The present invention relates generally to electronic equipment and, more particularly, to a system, apparatus and method for safely operating a mobile communication device in a vehicle.

### DESCRIPTION OF THE RELATED ART

Mobile communication devices such as, for example, mobile phones, PDA's, mobile computers, or the like, have become prevalent in business, personal, and other applications. While mobile communications devices provide numerous benefits to society, there are some drawbacks. In particular, simultaneous operation of a mobile communications device and a motor vehicle requires the user to devote part of his/her attention to operating the vehicle and part of his/her attention to using the mobile communications device.

Some have argued that hands free kits solve the problems associated with use of mobile communication devices while operating a vehicle. The particular thrust of this argument is that the hands free kit allows the vehicle operator to use both hands for driving the vehicle. However, the act of communicating, whether via a mobile communications device or face-to-face, requires a certain level of concentration by the communicator. When such communication is performed by an operator of a vehicle, his full attention may not be directed to the main task at hand, which is driving the vehicle.

### SUMMARY

The present invention enables a mobile communication device, such as a mobile phone or the like, to be automatically disabled when used in a moving vehicle. Alternatively, use in a moving vehicle may be permitted, but the user may be charged a premium, thereby discouraging such use. Further, exceptions may be made to allow use of the mobile phone in mass transit settings, such as on public transportation, and/or for passengers in an automobile.

Also, instead of or in combination with charging a premium for the communication time, a notification may be presented on at least one user's communication device, wherein the notification is indicative of use of a communication device in a moving vehicle. For example, if a communication is initiated by a first user who is in a moving vehicle, then the user receiving the communication (e.g., a call, text message, e-mail, etc.) may also receive a notification that the communication originator is in a moving vehicle. The notification may be a momentary event (e.g., a pre-recorded message, tone, video, etc.), or it may be ongoing for as long as at least one user is operating their communication device in a moving vehicle.

The notification message to the receiving party regarding the initiating party's device usage in a vehicle may be sent in various forms and rendered by the receiving party's device in various ways. For example, the notification may be sent as a voice message that is rendered in combination with the initiating party's voice. Alternatively, the notification may be sent as a multimedia message that includes audio, video, text and/or other control elements that cause the receiving party's device to behave in certain ways (e.g., beep, flash, vibrate, etc.). Other information, such as the vehicle speed, for example, may be included with the notification. The receiving party's communication device may display the communicating party's speed and/or produce an audible, visual and/or other type of alert when the speed exceeds a certain threshold.

In various embodiments, the notification may be tied to a velocity of the moving vehicle. For example, the alert volume may be proportional to the speed of the vehicle. Alternatively or in conjunction with the volume level, the speech or audio quality may be intentionally degraded (e.g., a fixed degradation or degradation proportional to speed of the vehicle). Such degradation may be one-way (e.g., affecting or perceived by only one party of the communication) or two-way (e.g., affecting or perceived by both parties of the communication).

Further, the notification may be conditioned on whether or not the initiating party is using a hands-free accessory. For example, the level of audio and/or video degradation when using a hands-free accessory may be less than the level of audio and/or video degradation when not using a hands-free accessory.

Also, it is possible that the user initiating the communication is not in a moving vehicle, but the recipient of the communication is. In this instance, the alert may be generated by the recipient's communication device and output on the initiating party's communication device. It is also possible to receive the notification on each communication device.

According to one aspect of the invention, there is provided a method of operating electronic equipment, wherein said electronic equipment utilizes a wireless signal to communicate. The method includes determining if the electronic equipment is operated within a moving vehicle based on a characteristic of the wireless signal; and inhibiting operation of the electronic equipment if the electronic equipment is in a moving vehicle.

According to another aspect of the invention, the characteristic of the wireless signal can be a timing advance or a Doppler shift of the wireless signal.

According to another aspect of the invention, a determination can be made whether a user of the electronic equipment is an operator or a non-operator of the moving vehicle.

According to another aspect of the invention, inhibiting can include inhibiting operation of the electronic equipment if said user is an operator of the moving vehicle.

According to another aspect of the invention, determining if a user of the electronic equipment is an operator or a non-operator can include using a near field device located at non-operator seating locations to enable operation of the electronic equipment while the vehicle is moving.

According to another aspect of the invention, inhibiting operation of the electronic equipment can be overridden by user operation of at least one user signal device at a periodic time interval.

According to another aspect of the invention, the user signal device can be at least one of a keypad of the electronic equipment or at least one button located near non-operator seating locations.

According to another aspect of the invention, operation of the user signal device can be in response to a prompt generated in on or in the electronic equipment.

According to another aspect of the invention, the prompt can include a code periodically displayed on a display device of the electronic equipment, and operation of the user signal device comprises re-entry of the code on a keypad of the electronic equipment.

According to another aspect of the invention, determining if the user of the electronic equipment is an operator or a non-operator can include determining that the user is a non-operator if the characteristic of the wireless signal is indicative of the vehicle is moving at a speed greater than a predetermined speed.

According to another aspect of the invention, the method can further include detecting Doppler shifts for a plurality of electronic equipment within a predefined area; and determining that said user is a non-operator of the moving vehicle when a plurality of electronic equipment in the same predefined area have substantially the same Doppler shift.

According to another aspect of the invention, all emergency communications can be enabled.

According to another aspect of the invention, the method can further include implementing a differential charge for use of the electronic equipment, said differential charge including a first rate and a second rate greater than the first rate, and wherein inhibiting operation includes allowing use of the electronic equipment only at the second rate if said user is an operator of the moving vehicle.

According to another aspect of the invention, determining if the electronic equipment is operated in a moving vehicle can include using the electronic equipment to determine the Doppler shift in the wireless signal and to inhibit operation of the electronic equipment.

According to another aspect of the invention, determining if the electronic equipment is operated in a moving vehicle can include using a wireless network to determine the Doppler shift in the wireless signal and to inhibit operation of the electronic equipment.

According to another aspect of the invention, the electronic equipment is a mobile phone.

According to another aspect of the invention, there is provided a method of providing information relating to electronic equipment usage in a vehicle to a third-party. The method can include monitoring electronic equipment usage parameters in the vehicle; and transmitting the parameters to the third party.

According to another aspect of the invention, the third-party and the user can have a contractual relationship.

According to another aspect of the invention, the contractual relationship can be between an owner of the vehicle and an insurance entity, and rates paid by the owner to the insurance entity are based at least in part on the usage parameters.

According to another aspect of the invention, monitoring can include using a receiver within the vehicle to monitor localized energy levels indicative of electronic equipment use in the vehicle.

According to another aspect of the invention, there is provided an electronic equipment, including: a motion circuit operable to determine a velocity of the electronic equipment based on a characteristic of a wireless signal used by the electronic equipment; and a control circuit configured to interrupt operation of the electronic equipment when said velocity corresponds to operation of the mobile phone in a moving vehicle.

According to another aspect of the invention, the characteristic of the wireless signal can be a timing advance or a Doppler shift of the wireless signal.

According to another aspect of the invention, there is provided a computer program embodied on a computer readable medium and operable in electronic equipment that utilizes a wireless signal, including: code that determines if the electronic equipment is operated within a moving vehicle based on a characteristic of the wireless signal; and code that inhibits operation of the electronic equipment if the electronic equipment is in a moving vehicle.

According to one aspect of the invention, a method of operating electronic devices includes: determining if a first electronic device is in communication with a second electronic device while said first electronic device is in a moving vehicle; and providing a notification on said second electronic device corresponding to said determination.

According to one aspect of the invention, providing the notification includes providing at least one of an audio message, a video message, or a text message.

According to one aspect of the invention, to claim 1, the method further includes varying an intensity of the notification in proportion to a speed of the vehicle.

According to one aspect of the invention, the method further includes: determining a speed of the vehicle; and including in said notification information indicative of said determined speed.

According to one aspect of the invention, determining the speed of the vehicle includes at least one of: using a sensor of the vehicle to determine the vehicle speed; using a Doppler shift of a signal received and/or transmitted by the first electronic device to determine the vehicle speed; or using a global positioning system of the first electronic device to determine the vehicle speed.

According to one aspect of the invention, providing the notification includes causing the second electronic device to operate in a predetermined manner.

According to one aspect of the invention, causing the second electronic device to operate in the predetermined manner includes at least one of vibrating the second electronic device, emitting one or more flashes of light from the second electronic device, or emitting one or more sound pulses from the second electronic device.

According to one aspect of the invention, the notification includes rendering a predetermined voice message in combination with the communication.

According to one aspect of the invention, the communication includes at least one of composing a text message, sending a text message, composing an e-mail message, sending an e-mail message, or sending voice data.

According to one aspect of the invention, providing the notification includes providing the notification only if it is determined that the first electronic device is in a moving vehicle.

According to one aspect of the invention, providing the notification includes degrading the quality of audio communicated between the first and second electronic devices.

According to one aspect of the invention, degrading the audio quality includes at least one of degrading the audio quality on only the first electronic device, or degrading the audio quality on only the second electronic device.

According to one aspect of the invention, degrading the audio quality includes degrading the audio quality in proportion to a speed of the vehicle.

According to one aspect of the invention, degrading the audio quality includes providing a warning on each electronic device that the audio will be degraded prior to degrading the audio quality.

According to one aspect of the invention, degrading the audio quality includes conditioning the audio degradation based on whether the first electronic device is being used with a hands-free device.

According to one aspect of the invention, the method further includes determining if a user of the first electronic device is an operator or a non-operator of the moving vehicle, and providing the notification only when the user of the first electronic device is an operator of the moving vehicle.

According to one aspect of the invention, determining if a user of the electronic device is an operator or a non-operator includes using a near field device to determine a location of the user in the vehicle.

According to one aspect of the invention, the method further includes providing the notification to a communication service provider of the first electronic device.

According to one aspect of the invention, an electronic device includes: a communication circuit adapted to provide two-way communication between the electronic device and at least one other device; a motion processing circuit adapted to determine if the electronic device is operated in a moving vehicle; and a control circuit adapted to provide a notification to the at least one other device, said notification corresponding to the results of the determination.

According to one aspect of the invention, the notification is at least one of an audio message, a video message, or a text message.

According to one aspect of the invention, the control circuit is further adapted to vary an intensity of the notification in proportion to a speed of the vehicle.

According to one aspect of the invention, the control circuit is further adapted to: determine a speed of the vehicle; and include in said notification information indicative of said determined speed.

According to one aspect of the invention, the control circuit is further adapted to use at least one of a sensor of the vehicle to determine the vehicle speed, a Doppler shift of a signal received and/or transmitted by the electronic device, or a global positioning system of the electronic device to determine the vehicle speed.

According to one aspect of the invention, the communication circuit is further adapted to receive a notification from the at least one other device, and the control circuit is further adapted to cause the electronic device to behave in a predetermined manner based on the notification.

According to one aspect of the invention, behaving in the predetermined manner includes at least one of: vibrating; emitting one or more flashes of light; or emitting one or more sound pulses.

According to one aspect of the invention, the control circuit is further adapted to use a predetermined voice message in combination with the communication as the notification.

According to one aspect of the invention, the communication includes at least one of composing a text message, sending a text message, composing an e-mail message, sending an e-mail message, or transmitting voice data.

According to one aspect of the invention, the control circuit is adapted to provide the notification only if it is determined that the electronic device is in a moving vehicle.

According to one aspect of the invention, the control circuit is further adapted to degrade the quality of audio received by or transmitted from the electronic device.

According to one aspect of the invention, the audio quality is degraded in proportion to a speed of the vehicle.

According to one aspect of the invention, the control circuit is further adapted to provide a warning that the audio quality will be degraded prior to degrading the audio quality.

According to one aspect of the invention, the control circuit is further adapted to condition the audio quality degradation based on whether the electronic device is used with a hands-free device.

According to one aspect of the invention, the control circuit is further adapted to determine if a user of the electronic device is an operator or a non-operator of the moving vehicle, inhibit said notification if the user is not an operator of the moving vehicle.

According to one aspect of the invention, a method of operating electronic devices includes: determining if a first electronic device is in communication with a second electronic device while said first electronic device is in a moving vehicle; and degrading at least one of an audio signal or a video signal communicated between said first and second devices based on said determination.

According to one aspect of the invention, degrading includes degrading the at least one audio and/or video signal on both the first and second electronic devices.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic diagram illustrating use of a mobile phone in a moving vehicle.

FIG. 2 is a schematic diagram illustrating an exemplary seating area of a vehicle in accordance with the invention.

FIG. 3 is a flow chart illustrating exemplary steps for carrying out a method of operating a mobile phone in a vehicle in accordance with the invention.

FIG. 4 is a flow chart illustrating exemplary steps for determining if a mobile phone is operated in a mass transit vehicle in accordance with the invention.

FIGS. 5A-5B are flow charts illustrating exemplary steps for determining if a mobile phone user is an operator of a vehicle in accordance with the invention.

FIGS. 6A-6B are flow charts illustrating exemplary steps for determining a velocity of a mobile phone based on a characteristic of a signal used by the mobile phone in accordance with the invention.

FIG. 7 is a flow chart illustrating exemplary steps for monitoring mobile phone activity within a vehicle in accordance with the invention.

FIG. 8 is schematic illustration of an exemplary mobile phone.

FIG. 9 is a schematic block diagram of a number of exemplary relevant portions of the respective mobile phone of FIG. 8 in accordance with the present invention.

FIG. 10 is a flow chart illustrating exemplary steps for providing a notification that a party to a communication is operating an electronic device in a moving vehicle in accordance with the invention.

FIG. 11 is a flow chart illustrating exemplary steps for receiving the notification generated in the method of FIG. 10, and acting on the notification in accordance with the invention.

### DETAILED DESCRIPTION OF EMBODIMENTS

The present invention will now be described with reference to the drawings, wherein like reference numerals are used to refer to like elements throughout.

The interchangeable terms “electronic equipment” and “electronic device” include portable radio communication equipment. The term “portable radio communication equipment,” which herein after is referred to as a “mobile radio terminal,” “mobile phone,” “mobile device,” or “mobile terminal”, and the like, includes all equipment such as mobile telephones, pagers, communicators, i.e., electronic organizers, personal digital assistants (PDAs), smartphones, portable communication apparatus or the like.

In the present application, the invention is described primarily in the context of a mobile phone. However, it will be appreciated that the invention is not intended to be limited to a mobile phone and can be any type of electronic equipment. As will be appreciated, the invention is applicable to both portable devices (e.g., hand held mobile phones) and non-portable devices (e.g., devices integrated within the vehicle, such as an integrated telematics system). As used herein, a telematics system refers to a mobile phone system integrated within the vehicle. With the exception of the portability and some functional differences, the telematics system of a vehicle performs many of the functions of a conventional hand-held mobile phone.

According to one aspect of the present invention, operation of electronic device, such as a mobile phone or the like, within a moving vehicle is detected based on a characteristic of a signal used by the electronic device. The characteristic may be, for example, a Doppler shift detected in the signal. Alternatively, the characteristic may be based on a location of the transmitting and/or receiving signal. As will be appreciated, other characteristics of the signal may be utilized to determine if the electronic device is in a moving vehicle.

If operation of the electronic device is determined to be within a moving vehicle and an emergency condition is not detected, then operation of the electronic device may be inhibited. Further, a determination can be made whether the user of the electronic device is an operator of the vehicle or a non-operator of the vehicle. If the user is an operator, then the electronic device may be inhibited, while if the user is a non-operator, the electronic device may not be inhibited. Alternatively, the operator of the vehicle may be given the option of paying a premium rate for using the electronic device while operating the vehicle, in which case the electronic device may remain in the operative state.

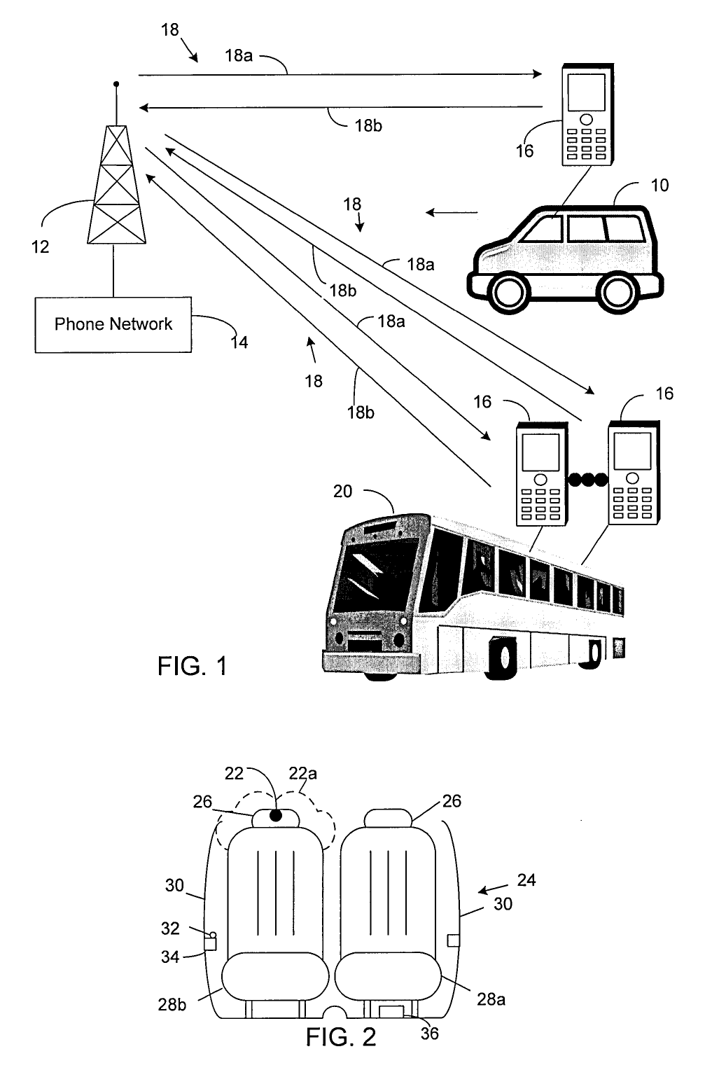

Referring now to FIG. 1, a vehicle 10 (e.g., a car, van, or the like) is shown moving in a direction toward a base station 12, such as a communication tower 12. The tower 12 is coupled to a mobile communication network 14, such as a mobile phone network, for example, as is conventional. Within the vehicle 10 is an electronic device 16, such as a mobile phone 16 or the like, wherein the mobile phone 16 is communicating over the network 14 via a signal 18. The signal 18 includes a first signal component 18a transmitted from the tower 12 and received by the mobile phone 16, and a second signal component 18b transmitted by the mobile phone 16 and received by the tower 12.

The signal 18a transmitted by the tower 12 is at a predetermined frequency, and the signal 18b transmitted by the mobile phone 16 also is at a predetermined frequency. As described in more detail below, based on a Doppler shift of the two signals 18a and 18b, a velocity of the mobile phone 16 can be determined. Once the velocity of the mobile phone 16 has been determined or otherwise calculated, the velocity can be compared to a preset velocity (e.g., a velocity greater than average walking or running velocity of a human, or some other preset velocity). If the calculated velocity is greater than the preset velocity, then it can be concluded that the mobile phone 16 is being operated in a vehicle, and operation of the mobile phone can be inhibited. For example, the network 14 and/or the mobile phone 16 may interrupt service (e.g., terminate the call and/or prevent incoming calls). Prior to interruption of service, the user may be given a warning or grace period in which he may normally terminate the call or stop the vehicle prior to the network 14 and/or phone 16 intervening.

As will be appreciated, there may be instances when the mobile phone 16 is being operated in a vehicle by a non-operator of the vehicle (e.g., a passenger). For example, the user of the mobile phone 16 may be a passenger of the vehicle (e.g., a second occupant in the vehicle 10, or a passenger in a public transportation vehicle, such as a bus 20 or other mass transit vehicle). In such circumstances, it is preferable that the mobile phone 16 be functional for non-operators (e.g., passengers) of the respective vehicles.

Passengers in the vehicle 10 can be identified in a number of different ways. For example, and with further reference to FIG. 2, a near field communications (NFC) sensor 22 may located in one or more seating areas 24 of the vehicle (e.g., one for each non-operator seat). The NFC sensor 22 may be located in a head rest 26 of a non-operator seat 28b, within the seat itself, or in close proximity to the seat 28b, e.g., in the door panel 30. If the mobile phone 16 and/or the vehicle are moving, operation of the mobile phone 16 may be allowed only if it is within range of the NFC sensor 22. Additionally, the NFC sensor 22 may communicate with and/or be under the control of a telematics system 36 of the vehicle 10, such that the telematics system 36, the phone 16 and/or network 14 inhibit communications when the vehicle is determined to be moving and the phone 16 is not within range of the NFC sensor 22

Alternatively, if the mobile phone 16 is detected in a moving vehicle 10, operation of the mobile phone 16 may be allowed if the user periodically presses a signal device, such as a button 32 or the like, mounted near non-operator seating locations. For example, a button 32 may be located on the door panel 30 or in an arm rest 34 of a non-operator seating location, wherein the button 32 is coupled to the telematics system 36 of the vehicle 10. To allow operation of the mobile phone 16 in the moving vehicle 10, the user periodically presses the button 32. Since the button 32 is only accessible from a non-operator seating location, the telematics system 36 knows the user is not operating the vehicle 10 and therefore does not interfere with the mobile phone's operations. Instead of a periodically pressing the button 32, the user may be required to hold the button 32 for the duration of the call. As will be appreciated, other scenarios may be implemented, such as using multiple buttons (pressing multiple buttons simultaneously or in sequence), for example. Further, in the case where the vehicle includes a telematics system 36 and a separate hand-held mobile phone is used within the vehicle, the telematics system 36 may communicate with the hand-held mobile phone (e.g., via Bluetooth or the like) so as to enable/disable the mobile phone based on signals received by the telematics system 36 via the button 32.

In another embodiment, the mobile phone 16, if detected in a moving vehicle 10, may periodically display a code on its display device. The user then would have a predetermined amount of time to enter the code back into the mobile phone 16 (e.g., via the phones key pad or the like). Failure to enter the code in the allotted time would place the mobile phone 16 in an inoperable state (e.g., terminate and/or prevent communications).

Allowing mobile phone operation in mass or public transportation vehicles, such as a bus, street car, train, or the like, is preferable, since such use is not a safety concern as the users are not operating the vehicle. As will be appreciated, there may be a number of mobile phones in use on a mass transit vehicle at any given time. By identifying a number of mobile phones experiencing the same Doppler shift, such phones can be said to be on the same vehicle, such as a mass transit vehicle and, therefore, operation of the mobile phone may be allowed.

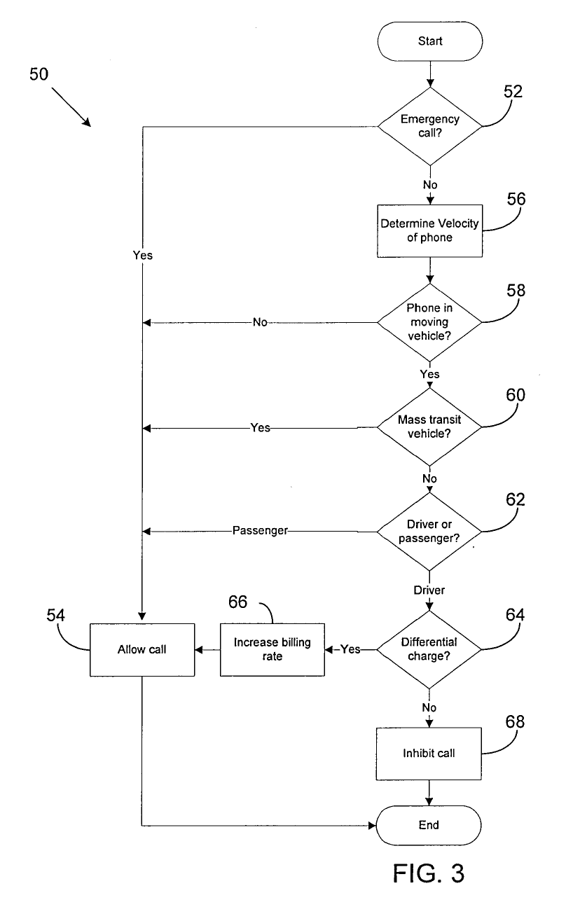

Moving now to FIG. 3, a flow chart 50 is shown illustrating exemplary steps for safely operating electronic equipment in a moving vehicle. The flow charts described herein include a number of process blocks arranged in a particular order. As should be appreciated, many alternatives and equivalents to the illustrated steps may exist and such alternatives and equivalents are intended to fall within the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at block 52, it is determined if the communication is an emergency communication or a normal communication. Emergency communications can include, for example, calls to the police department, fire department, medical services, or the like. Such communications may be identified, for example, by the number dialed by the user. More specifically, emergency numbers, such as 911 or other emergency numbers, can be stored in memory of the mobile phone 10 and/or network 14. If a number is dialed that matches an identified emergency number, then at block 54 the mobile phone 16 is placed in the operative state and the communication is allowed. However, if the communication is not an emergency communication, then at block 56 the velocity of the mobile phone is determined.

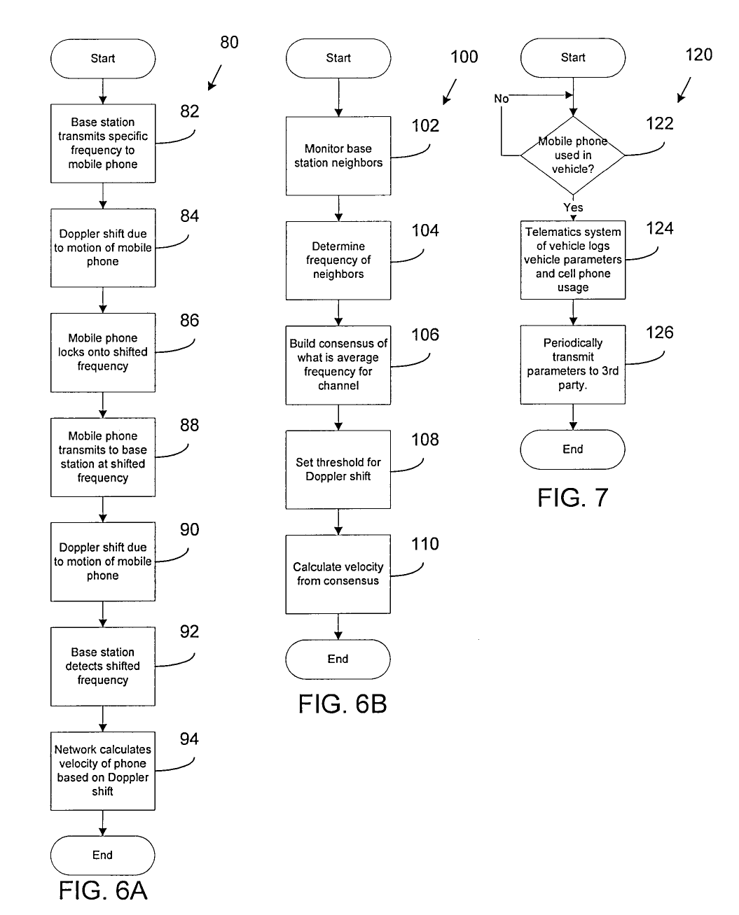

The velocity of the mobile phone 16 can be determined based on a characteristic of a signal 18 used by the mobile phone 16. For example, the Doppler shift of the signal 18 can be determined using conventional techniques and, based on the Doppler shift, the velocity of the phone can be calculated. Alternatively, as the mobile phone 16 moves through an area, it continuously scans neighboring towers 12 for better signal quality. Contact with each neighboring tower 12 can be logged by the network 14 and/or the mobile phone 16, and then analyzed so as to determine an approximate velocity of the mobile phone 16. Further details for determining a velocity of the mobile phone are discussed with respect to FIGS. 6A and 6B below.

Moving to block 58, the velocity of the mobile phone 16 is analyzed to determine if the mobile phone 16 is in a moving vehicle. This may be accomplished, for example, by comparing the velocity of the mobile phone 16 relative to a preset value. If the mobile phone 16 is not moving (e.g., zero velocity) or is moving but at some value less than the preset speed, then it can be concluded that the mobile phone 16 is not in a moving vehicle and the communication is allowed, as indicated at block 54. However, if the velocity is greater than the preset value, then at block 60 a determination is made whether the vehicle is a mass transit vehicle or a standard passenger car.

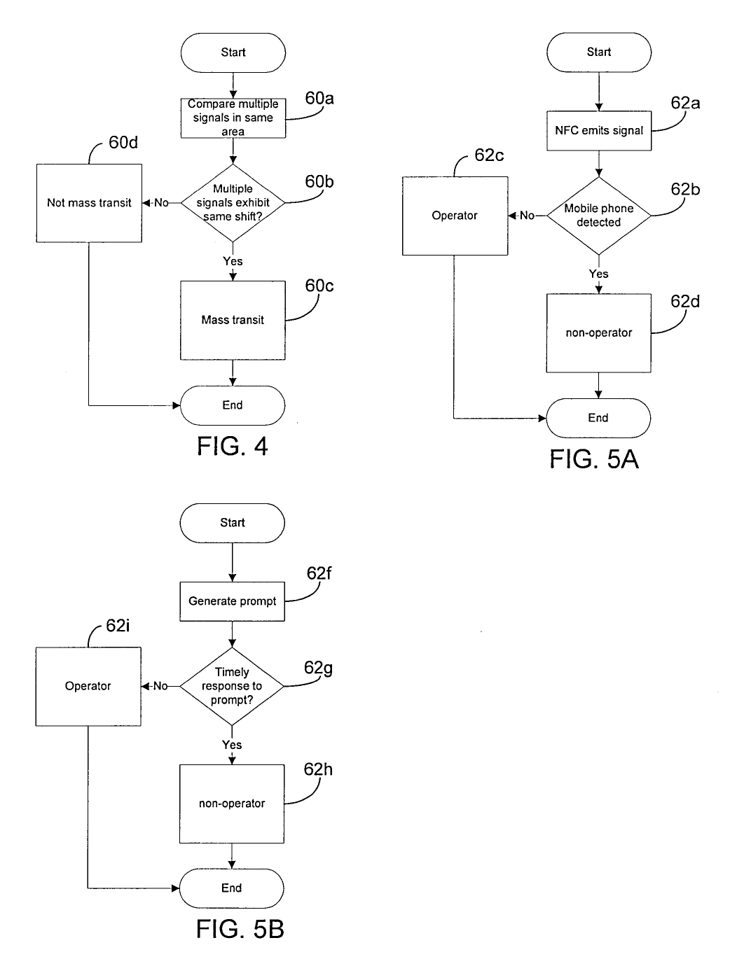

Use of a mobile phone 16 on a mass transit vehicle can be determined, for example, by the presence of multiple signals 18 in the same area experiencing the same Doppler shift, by a velocity of the vehicle (e.g., a velocity above a preset threshold) or by a location of the signal 18 (e.g., in a known mass transit corridor). For example, and with further reference to FIG. 4, signals originating in the same general area (e.g., via the same tower 12) can be compared to each other, as indicated at block 60a. At block 60b, it is determined if multiple signals (e.g., two, three, four or more) exhibit substantially the same Doppler shift within the same area (e.g., within the same cell). If such signals exhibit the same Doppler shift, then at block 60c the respective mobile phones 16 using the signals 18 are said to be on a mass transit vehicle. However, if the signals exhibit different Doppler shifts, then at block 60d it is concluded that the signals are not originating from a mass transit vehicle.

Instead of checking for a number of signals exhibiting the same Doppler shift in the same general area, use of a mobile phone 16 on a mass transit vehicle may be determined in other ways. For example, certain mass transit vehicles, such as trains, may travel at substantially higher speeds than automobiles. To detect use of a mobile phone 16 on a train, a threshold velocity can be set that is higher than typical automobile speeds. If the speed of the mobile phone 16 exceeds this threshold velocity, then it can be concluded that the mobile phone 16 is being operated on a mass transit vehicle.

Yet another way of determining use of the mobile phone 16 on a mass transit vehicle is based on a location of the mobile phone 16. More particularly, mass transit vehicles may be routed through corridors that are not accessible by automobiles. By detecting use of the mobile phone 16 in such corridors (e.g., based on a GPS determined position of the mobile phone or based on the tower 12 servicing the mobile phone), it can be concluded that the mobile phone 16 is being used in a mass transit corridor, and thus on a mass transit vehicle.

Referring back to FIG. 3, if the vehicle 10 is determined to be a mass transit vehicle, then the method moves to block 54 and communication is allowed. However, if the vehicle 10 is determined to not be a mass transit vehicle, then at block 62 it is determined if the user of the mobile phone 16 is a driver or passenger of the vehicle 10.

Determination of whether the user is a driver (operator) or passenger (non-operator) can be accomplished via the aforementioned NFC sensor 22. Since the NFC sensor is only in non-operator seating locations, an operator cannot simultaneously operate the vehicle and place the phone in non-operator locations. For example, and with further reference to FIG. 5A, communications may be enabled only when the mobile phone 16 is within range of the NFC sensor 22. As shown at block 62a, the NFC emits and/or scans for a signal to/from the mobile phone 16. If the mobile phone is not detected (i.e., it is not in range of the NFC), then at block 62c the user is said to be in operator, as indicated at block 62c. If the mobile phone 16 is detected, then at block 62 d the user is said to be a non-operator.

Alternatively or in addition to, the NFC sensor 22 can be coupled to the telematics system 36 and/or the network 14 (or other WAN) such that coded messages may be transmitted to the NFC sensors and/or the mobile phone 16, and then back to the network 14. If these codes do not match in relatively close time alignment, the phone may not be activated.

Another way in which a determination can be made regarding the user's status within the vehicle is shown in FIG. 5B. Beginning at block 62f, a prompt is generated on the mobile phone's display when the phone's velocity is greater than a preset value. The prompt may be a request to enter a code as provided on the display. At block 62g, it is determined if a response to the prompt was timely made (e.g., was the response entered within a predetermined amount of time). If the response was entered within the allotted time, then at block 62h the user is considered to be a non-operator of the vehicle (a passenger). However, if the response was not entered within the allotted time, then at block 62i the user is consider an operator of the vehicle (a driver).

A variation of the method of FIG. 5B can include using a signaling device accessible only in non-operator seating areas. For example, instead of entering a code into the mobile phone 16 via a keypad, a user signaling device, such as one or more buttons 32, can be coupled to a telematics system 36 of the vehicle 10. When the mobile phone is in use, the user may periodically or continuously operate the one or more signaling devices (e.g., continuously hold the one or more buttons 32 or operate the buttons 32 in a predetermined sequence). The telematics system 36 then can provide this information to the network 14 and/or to the phone 16 so as to determine if the user is an operator or non-operator of the vehicle. For example, failure to operate the signaling devices may be interpreted as use of the mobile phone 16 by an operator of the vehicle, while use of the signaling devices may be interpreted as use of the mobile phone by a non-operator of the vehicle.

Moving back to FIG. 3, regardless of how the determination between operator and non-operator is made, if the user is a non-operator of the vehicle (a passenger), then the mobile phone 16 can remain in the operative state, and the communication is allowed as indicated at block 54. However, if the user is an operator of the vehicle (a driver), then the communication may be allowed if the user agrees to an increase in the billing rate for the communication (e.g., a higher cost per minute), as indicated at block 64. For example, the user may be provided with a message indicating that use of the mobile phone 16 while operating the vehicle 10 will incur a higher billing rate. The message may inquire whether or not the user wishes to pay a higher fee for use of the mobile phone 16 while operating the vehicle 10. In response to the message, the user may accept the higher billing rate via keypad entry or voice command, for example. If the user accepts the higher billing rate, then at block 66 the user is charged a premium for the time in which the mobile phone 16 is used while operating the moving vehicle 10, and at block 54, the communication is allowed. If the user does not accept the higher billing rate, then at block 68 operation of the mobile phone is inhibited.

Referring now to FIG. 6A, there is provided a flow chart 80 showing exemplary steps for determining a velocity of a mobile phone 16 based on a Doppler shift of signals 18 transmitted between the mobile phone 16 and the tower 12. In establishing a communication link, signals 18 are exchanged between the tower 12 and the mobile phone 16. As indicated at block 82, the signal frequency transmitted by the tower 12 is at a predetermined frequency, such as 10 MHz, for example. Due to motion of the mobile phone 16 relative to the tower 12, a Doppler shift is introduced, and the frequency of the signal 18a as perceived by the mobile phone 16 is different from the transmitted frequency, as indicated at block 84. At block 86, the mobile phone 16, using conventional techniques, receives the signal 18a and locks on to the Doppler shifted frequency, which is different from the transmitted frequency at the tower 12. For example, if the signal 18a is transmitted from the tower 12 at 10 MHz, and the mobile phone 16 is traveling away from the tower 12, the mobile phone 16 will see and lock onto the signal 18a at a frequency less than 10 MHz (e.g., 9.9 MHz). If the mobile phone is traveling toward the tower 12, then the mobile phone 16 will see and lock onto the signal 18a at a frequency greater than 10 MHz (e.g., 10.1 MHz). The exact frequency depends on the velocity of the mobile phone 16 relative to the tower 12.

In addition to receiving signals from the tower 12, the mobile phone 16 also transmits signals to the tower 12. As the mobile phone 16 transmits a signal 18b to the tower 12, the signal 18b is transmitted at a frequency that corresponds to the Doppler shift detected in the signal 18a, as indicated at block 88. For example, if the signal 18a was transmitted at 10 MHz and detected by the mobile phone 16 at 9.9 MHz, then when the mobile phone 16 transmits signal 18b to the tower 12, the signal 18b will be transmitted at 9.9 MHz.

As the signal is transmitted back to the tower 12 by the moving phone 16, the signal 18b from the point of view of the tower 12 also undergoes a Doppler shift, as indicated at block 90. For example, and as noted above, the signal 18b transmitted by the mobile phone 16 will be at a frequency corresponding to the detected frequency of the signal 18a (e.g., it is transmitted at 9.9 MHz). Due to the motion of the phone 16 relative to the tower 12, the tower 12 will detect the signal with an additional Doppler shift, causing the detected signal 18b to appear even lower in frequency (e.g., 9.8 MHz), as indicated at block 92. Using conventional techniques, the data corresponding to the Doppler shift can be used to calculate a velocity of the mobile phone 16, as indicated at block 94. The calculation may be performed by the network 14, or by the mobile phone 16.

Another method of determining the velocity of the mobile phone 16 based on a characteristic of the wireless signal 18 includes monitoring the timing advance of the burst from a GSM (global system for mobile communication) tower. The term “timing advance” in GSM corresponds to a step change in an approximation of the number of microseconds the signal 18 requires to travel from the mobile phone 16 to the tower 12 or vice versa. GSM uses TDMA (time division multiple access) technology in the radio interface to share a single frequency between several users (e.g., eight users), wherein each user of the several users is assigned sequential timeslots. Each user transmits periodically for less than one-eighth of the time, within one of the eight timeslots. Since the users are various distances from the tower 12 and radio waves travel at the finite speed of light, the precise time at which the phone 16 is allowed to transmit and/or receive a burst of traffic within a timeslot is adjusted accordingly. Timing Advance (TA) is the variable controlling this adjustment.

As the mobile phone 16 moves relative to the tower 12, the timing advance may increase or decrease so as to ensure that communications are optimum. By detecting the amount of timing advance present in the signal 18, the velocity of the mobile phone 16 relative to the tower 12 can be calculated.

Referring now to FIG. 6B, a flow chart 100 illustrating exemplary steps for determining a velocity of the mobile phone 16 in accordance with another embodiment of the invention is provided. Beginning at block 102, the mobile phone 16 monitors signals 18 from the tower 12 as well as signals from neighboring towers 12. For example, in an effort to obtain the best possible signal, the mobile phone 16 may scan signals from neighboring towers 12 to determine if a better quality signal is available. In scanning the neighboring towers, the mobile phone 16 determines the frequency of the signal 18 received from each tower, as indicated at block 104. Each of the scanned signals, however, may be skewed or shifted (Doppler shift) from their frequency as transmitted by the respective tower. At block 106, an average frequency is calculated based on the signal frequencies detected from the tower 12 and neighboring towers 12 (e.g., the frequencies are summed and then divided by the total).

At block 108, a threshold is set for detecting when the Doppler shift is sufficiently large so as to infer the mobile phone is moving in a vehicle. In other words, the threshold (Doppler shift) for detecting vehicle motion is set so as to prevent movement of the mobile phone 16 due to walking or running by the operator as being interpreted as vehicle motion.

At step 110, the detected frequencies from each tower (current tower and neighboring towers) are compared to the average frequency as determined at block 106. From this comparison, multiple Doppler shifts can be inferred. If signals from a predetermined number of towers exhibit a Doppler shift greater than the threshold level set at block 108, then it may be concluded that the mobile phone is in a moving vehicle. Further, the accuracy of the estimated velocity may be improved by performing an RMS calculation using the Doppler components obtained from each tower. Performing an RMS calculation on the Doppler components removes the problems associated with some Doppler components being positive values and other Doppler components being negative values.

Moving now to FIG. 7, a flow chart 120 is provided showing exemplary steps for logging data relating to operation of a mobile phone 16 in a vehicle 10. The method of FIG. 7 can be useful, for example, when a contractual relationship exists between the vehicle owner and a third party. The contractual relationship may be in the form of an automobile insurance policy, for example, wherein insurance rates are set or altered based on certain driving habits of the vehicle owner. These safety considerations may include, for example, the amount of time the vehicle operator uses the mobile phone while driving the vehicle.

Beginning at block 122, it is determined whether or not a mobile phone 16 is in use within the vehicle 10. This determination can be made by a telematics system 36 of the vehicle and/or NFC sensors 22 as discussed herein, or via a separate receiver within the passenger compartment that monitors localized energy levels in a cellular uplink band. Further, the detection can include detection of both the operator of the vehicle (driver) and/or a non-operator of the vehicle (a passenger). If use of the mobile phone is detected within the vehicle, then the method loops at block 122. However, if use of the mobile phone 16 is detected in the vehicle 10, then at block 124 the telematics system 36, in addition to phone usage data, logs vehicle parameters, such as speed, acceleration, deceleration, use of turn signals, g-forces, or any other parameter that may be used to determine safe or unsafe driving conditions.

The data may be stored in memory of the telematics system 36, such as non-volatile RAM or the like.

At block 126, the telematics system 36 periodically transmits the logged data to a third party, such as an insurance carrier of the vehicle 10. The data then can be analyzed to determine if the driver practices safe driving habits. By monitoring the vehicle operator's driving habits, particularly mobile phone usage, insurance rates can be increased or decreased based on predefined criteria. The threat of an increase in insurance premiums may encourage the operator to minimize or eliminate mobile phone usage while operating the vehicle.

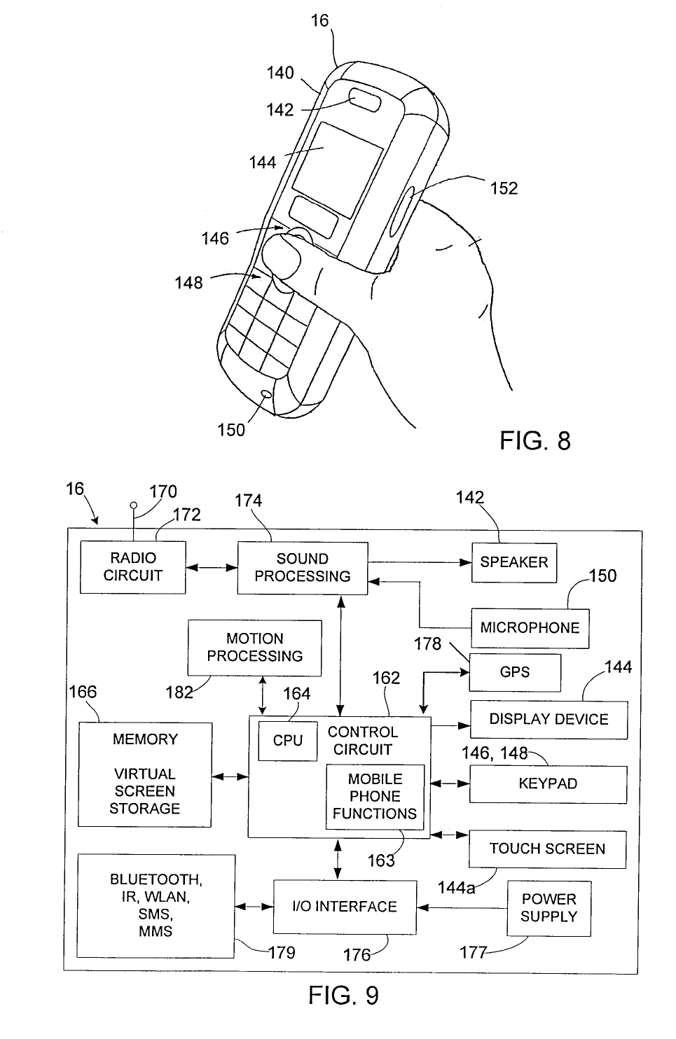

Referring now to FIG. 8, an exemplary portable mobile phone 16 is shown that may be used in accordance with the invention. The mobile phone 16 has a “brick” or “block” design type housing 140, but it will be appreciated that other type housings, such as, for example, claim shell or slide-type housings, may be utilized without departing from the scope of the invention. The mobile phone 16 includes housing 140 (sometimes referred to as a case), speaker 142, display 144, navigation switch and selection/function keys or switches 146, key pad 148, microphone 150, and volume control slide switch 152; these are illustrative and exemplary of parts of a typical mobile phone, but it will be appreciated that other parts that are similar or different in form and/or function may be included in the mobile phone 16. The mobile phones to which the invention pertains also may be of the types that have more or fewer functions, keys, etc., compared to those illustrated and described herein.

As will be appreciated, the mobile phone 16 may function as a conventional mobile phone. The mobile phone 16 may have additional functions and capabilities that may be developed in the future. From a conventional point of view, the display 144 displays information to a user, such as operating state, time, phone numbers, contact information, various navigational menus, etc., which facilitate and/or enable the user to utilize the various features of the mobile phone. The display also may be used to view movies, images, or to play games, for example. Part or all of the display 144 may be a touch screen type device 144a (FIG. 9). The navigation and function keys 146 and the keypad 148 may be conventional in that they provide for a variety of user operations. For example, one or more of the function keys and navigation device 146 may be used to navigate through a menu displayed on the display 144 to select different phone functions, profiles, settings, etc., as is conventional. The keypad 148 typically includes one or more special function keys, such as, a “call send” key for initiating or answering a call, a “call end” key for ending or hanging up a call, and dialing keys for dialing a telephone number. Other keys included in the navigation and function keys 146 and/or keypad 148 may include an on/off power key, a web browser launch key, a camera key, a voice mail key, a calendar key, etc. The volume control switch 152 may be operated to increase or to decrease the volume of the sound output from the speaker 142. If desired, a sensitivity control also may be provided to change the sensitivity of the microphone 150 as it picks up sounds for transmission by the mobile phone 16. The mobile phone 16 may have more of fewer keys, navigation devices, etc., compared to those illustrated.

FIG. 9 represents a functional block diagram of an exemplary mobile phone, for example, the mobile phone 16. The representation also is similar to those of PDAs, non-portable phones (e.g., telematic systems of a vehicle) and/or other electronic equipment, as will be appreciated by those having ordinary skill in the art. The various functions carried out by the parts represented in the functional block diagram of FIG. 9 may be carried out by application software within the mobile phone 16. However, it will be apparent to those having ordinary skill in the art that such operation can be carried out via primarily software, hardware, firmware, or a combination thereof, without departing from the scope of the invention.

The mobile phone 16 includes a primary control circuit 162 that is configured to carry out overall control of the functions and operations of the mobile phone 16, e.g., as is represented at block 163. The control circuit 162 may include a CPU 164 (central processor unit), microcontroller, microprocessor, etc., collectively referred to herein simply as CPU 164. The CPU 164 executes code stored in memory within the control circuit 162 (not shown) and/or in a separate memory 166 in order to carry out conventional operation of the mobile phone functions within the mobile phone 16. In addition, the CPU 164 executes code stored in the memory 166, for example, or in some other memory (not shown) in order to perform the various functions of detecting motion based on signals provided by the motion transducer 160 and to alter the display data based on the detected motion.

Continuing to refer to FIG. 9, the mobile phone 9 includes a conventional antenna 170, radio circuit 172, and sound processing signal circuit 174, all of which are cooperative to send and to receive radio frequency (or other) signals in conventional manner. For an incoming signal, for example, the sound processing signal circuit 174 may include an amplifier to amplify the signal and to provide it to the speaker 142 so a user may hear the sound, and the sound processing signal circuit 174 also may use the same amplifier or another amplifier to amplify signals from the microphone 150 for transmitting thereof via the radio circuit 172 and antenna 170 to another mobile telephone, to a cellular phone tower, to a satellite, etc. Operation of the radio circuit 172, sound processing signal circuit 174, speaker and microphone, are under control of the control circuit 172, as is conventional.

The mobile phone 16 includes the display device 144, keypad 146, 148 (including the navigation device mentioned above), and the capability of a touch screen 144a, which may be part or all of the display device 144, and these are coupled to the control circuit 162 for operation as is conventional.

As is illustrated in FIG. 9, the mobile phone 16 includes an input/output interface 176, a power supply 177, a GPS receiver 178, and a short distance communications mechanism 179, for example a Bluetooth communications device, infrared (IR) communications device, or some other device. Another example of a short distance communications mechanism is wireless local area network (WLAN), and the mobile phone 16 also may use still other short distance communications mechanisms or devices that currently exist or may be developed in the future. The short distance communications mechanism 179 may transmit and receive signals using SMS (short message service), MMS (multimedia messaging service) or some other communications mechanism and protocol. Bluetooth, IR, WLAN communications for communicating over short distances between mobile phones are well known; other mechanisms may exist and/or may be developed in the future, and these may be utilized by and are included for use in the invention.

A motion processing circuit 182 determines a velocity of the mobile phone based on a characteristic of a wireless signal used by the mobile phone. More specifically, and as discussed herein, the motion processing circuit 182 can determine a Doppler shift in a wireless signal used by the mobile phone 16. The Doppler shift then is used to calculate a velocity of the phone. Based on the velocity, the mobile phone may be enabled or disabled as discussed herein.

Alternatively, the motion processing circuit 182 may receive velocity data from a sensor of the vehicle. For example, the vehicle may have an on-board computer system that receives wheel speed data, which is converted by the computer into vehicle speed. This calculated vehicle speed can be transmitted to the mobile phone via a short range wireless connection, such as a Bluetooth connection, for example. The motion processing circuit then can simply analyze the velocity data to determine if the vehicle is moving, and infer such motion onto the mobile phone. Instead of receiving actual vehicle speed from the vehicle's computer, the motion processing circuit may receive raw data corresponding to vehicle speed, and the motion processing circuit may determine the vehicle speed from the raw data. In yet another embodiment the velocity is determined based on GPS data (e.g., from a GPS sensor in the mobile phone.

According to another aspect of the invention, communications (e.g., text messages, email, messages, voice communications, etc.) are allowed while in a moving vehicle, but at least one party, such as the party not in the moving vehicle, receives a notification that the other party is communicating while in a moving vehicle.

For example, a determination is made if at least one mobile terminal used in a multi-party communication is in a moving vehicle and/or in use by an operator of the moving vehicle. Determination of vehicle and/or mobile terminal motion may be made using any of the previously discussed techniques (e.g., Doppler shift, GPS, vehicle sensors, etc.). If it is determined that a mobile terminal is not being operated in a moving vehicle (or not operated by an operator of the vehicle), then the mobile terminal may be used in a conventional manner. However, if it is determined that at least one mobile terminal of a multi-party communication is being operated in a moving vehicle and/or by an operator of the moving vehicle, then a notification is generated corresponding to such use, and the notification is provided to other parties to the communication (including parties that are using conventional non-mobile terminals, such as desk phones).

As used herein, a notification is defined as an audible, visual and/or physical alert indicative of whether or not a mobile terminal is in use in a moving vehicle. Preferably, the notification is indicative of at least one mobile terminal being operated in a moving vehicle. However, there could be multiple types of notifications, each signifying a specific operational status of the mobile terminal (e.g., use in a moving vehicle, use in a non-moving vehicle, or use outside a vehicle). For example, as a communication is initiated wherein no mobile terminals are in used in a moving vehicle, then the parties to the communication may receive a notification embodied as a pleasant jingle. Should one mobile terminal subsequently be used in a moving vehicle, then a new notification can be issued indicative of such use (e.g., a high-pitched audio signal).

Preferably, the notification is provided on the terminal (e.g., other mobile terminal, desk phone, etc.) that is not in a moving vehicle, although it may be provided on each terminal (so long as at least one terminal is in use in a moving vehicle). The notification may be by way of an audio message (including speech and/or sound tones), a video message (including moving or stationary images, flashes of light, etc.), a text message, etc., or combination thereof. The notification may be sent in various forms and rendered by the receiving party's terminal in various ways. For example, the notification may be sent as a voice message (e.g., an AMR-encoded file) that is rendered in combination with the calling party's voice. Alternatively, the audio message may be a pre-recorded message that resides on the receiving terminal and is triggered by information transmitted from mobile terminal in the moving vehicle. For example, a text message, a multimedia message, or the like can be automatically generated and transmitted to the receiving terminal, wherein the message causes the receiving terminal to play the message. The message may be rendered in combination with the message generated by the user in the moving vehicle, or it may be output separately (e.g., sequential output).

Further, the notification may be conditioned based on velocity of the moving vehicle. For example, if the vehicle/terminal is moving below a first predetermined threshold velocity, then the notification may be output at a first volume level (e.g., a low volume level). If the vehicle/terminal is moving above the first predetermined threshold velocity, then the notification may be output at a second volume (e.g., a high volume level). In another embodiment, the volume level of the notification is proportional to the vehicle speed (e.g., the volume increases or decrease in proportion to the speed of the vehicle/terminal). Also, the notification itself may include the velocity (e.g., the notification continuously or intermittently announces or displays the speed of the moving vehicle/terminal).

The notification may cause one or each of the terminals to behave in a predetermined manner. For example, upon receiving the notification, the receiving terminal may continuously or intermittently vibrate. Further, continuous or intermittent sound pulses may be emitted by the terminal, and/or continuous or intermittent light flashes may be emitted by the terminal.

In addition to the above-referenced notification, the audio and/or video quality of the communication may be intentionally degraded. Alternatively, the notification itself may be inferred by way of audio and/or video degradation.

The audio and/or video degradation can be one-way (i.e., affecting only one party of the communication) or two-way (i.e., affecting two or more parties to the communication). Also, the audio and/or video degradation can be conditioned based on velocity of the moving vehicle. For example, and as discussed above with respect to the notification, if the vehicle is moving below a first predetermined threshold velocity, then the audio and/or video may be degraded to a first degradation level. If the vehicle is moving above the first predetermined threshold velocity, then the audio and/or video may be degraded to a second degradation level, wherein the second degradation level results in audio and/or video output that is of poorer quality than that produced by the first degradation level. Alternatively, the degradation level can be proportional to the vehicle speed (e.g., the audio and/or video degradation increases or decreases in proportion to the speed increase or decrease of the vehicle/terminal).

Audio and/or video degradation also may be conditioned based on whether the party in the moving vehicle is using a hands-free accessory. For example, if a hands-free accessory is not being used, then audio and/or video degradation may be carried out as described above. If the party is using a hands-free accessory, then the audio and/or video degradation may be carried out, but the level of degradation may be reduced relative to the case where a hands-free accessory is not in use.

Prior to degrading the audio and/or video, a warning may be provided on each electronic device. The warning gives notice to the communicating parties that if the moving vehicle is not stopped or the speed is not reduced below a predetermine level, then the audio and/or video will be degraded. Preferably, the parties are given sufficient notice such that the vehicle may be safely brought below the desired speed and/or stopped (e.g., 30 seconds or more).

The audio and/or video degradation may be implemented, for example, by inserting errors in one or more bits in one or more speech and/or video frames. Further, the error insertion rate may increase or decrease based on vehicle speed. At certain speeds, the errors would reach a sufficient level such that the audio and/or video become meaningless.

In addition to providing the notification to at least one of the parties to the communication, the network service provider also may be notified of use of the mobile terminal in a moving vehicle. This enables the service provider to manage the communication in a more uniform standard as that standard is developed over time. For example, the service provider may be able to include information pertaining to violations of local statues (e.g., provide a warning that according to the local municipality's laws, it is illegal to operate a mobile terminal in a moving vehicle). Alternatively, the service provider may charge a premium for using the mobile terminal while in a moving vehicle.

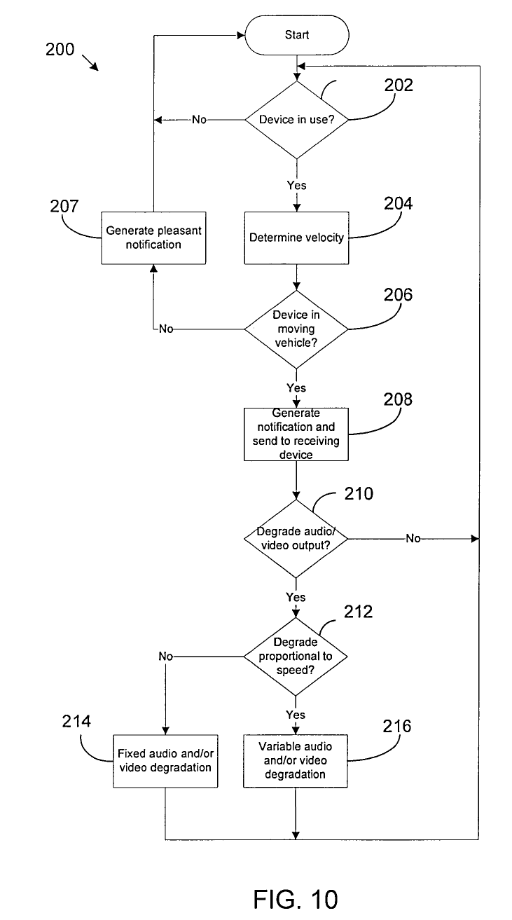

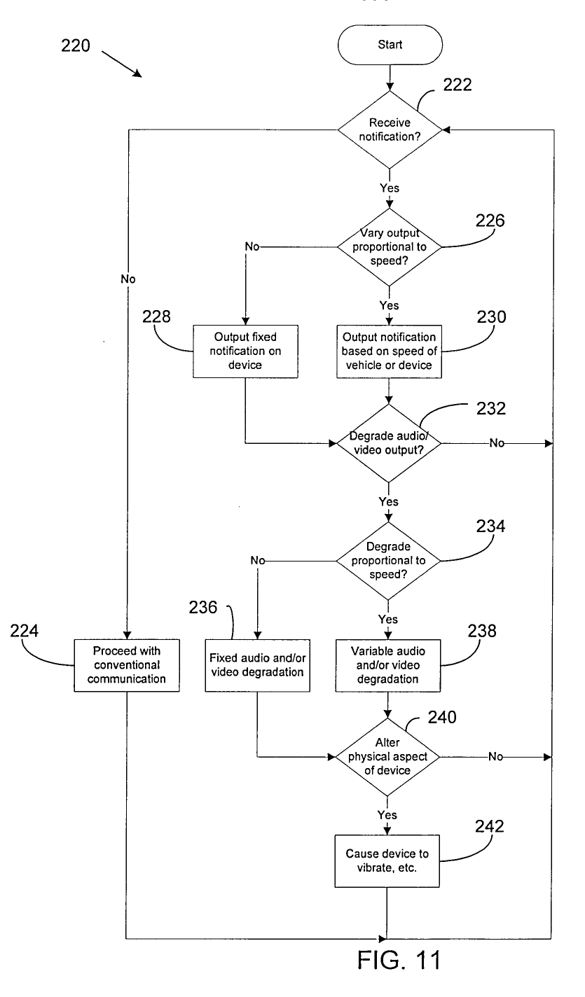

Moving now to FIGS. 10 and 11, two flow charts 200 and 220 are shown that illustrate the exemplary method of providing a notification as described above. FIG. 10 pertains to detection of a mobile terminal in a moving vehicle and the generation of the notification. FIG. 11 pertains to a terminal (mobile or fixed/stationary terminals) receiving the notification generated in FIG. 10, and acting on the notification.

Beginning at block 202 of FIG. 10 it is determined if the mobile terminal is in use. For example, is a communication being initiated, or is a communication ongoing? If the mobile terminal is not in use, then the method loops at block 202. If the mobile terminal is in use, then at block 204 the velocity of the mobile terminal and/or the vehicle (from which the mobile terminal's velocity can be inferred) is determined. The velocity of the mobile terminal and/or the vehicle can be determined using any of the techniques described herein, including determining the velocity based on the Doppler shift of the signal received and/or transmitted by the mobile terminal, via GPS assistance, and/or from data obtained from the vehicle.

Next at block 206, it is determined if the velocity is sufficient to classify the mobile terminal as being in a vehicle. For example, any velocity less than a predetermined threshold (e.g., 10 miles per hour) can be considered as not being in a moving vehicle, while velocities above this threshold can be considered as being in a moving vehicle. If it is determined that the mobile terminal is not in a moving vehicle, then the method moves to block 207 where a pleasant notification (e.g., a pleasant jingle) may be generated and sent to the other terminals as an indication that the mobile terminal is not in a moving vehicle. The method then moves to block 202 and repeats. However, if it is determined that the mobile terminal is in a moving vehicle, then at block 208 a notification is assembled or otherwise generated by the mobile terminal, and then transmitted to the other terminals in communication with the moving mobile terminal.

The notification may take the form of a text message, a multimedia message, a file, or the like that is transmitted from the moving mobile terminal to the terminal in which a communication link has been established. The notification may include control code or the like that can further instruct the receiving terminal how to output the notification. For instance, the moving mobile terminal may have one or more audio messages pertaining to the various notifications stored in complete form in its memory, and it extracts the appropriate one from memory and sends to the far-end terminal. Alternately, the moving mobile terminal may have an audio message template stored in memory, which it fills with additional audio information that is appropriate to the present circumstances (e.g., speed of the vehicle) prior to sending to the far-end terminal. Furthermore, in either case, the moving mobile terminal may adjust the levels of the audio message based on the present circumstances (e.g., speed of the vehicle) prior to sending to the far-end terminal.

Upon generating and sending the notification, the method moves to block 210 wherein it is determined if the audio and/or video output is to be degraded on the moving mobile terminal. As noted herein, degradation of the audio and/or video may be performed on only one terminal, or it may be performed on a plurality of terminals, including the mobile terminal in the moving vehicle. Degradation may be performed at the terminal of the party receiving the audio and/or video intended to be degraded, or at the terminal of the party transmitting the audio and/or video intended to be degraded.

If the audio and/or video is/are not to be degraded, then the method moves back to block 202. However, if the audio and/or video is/are to be degraded, then at block 212 it is determined if the degradation should be a fixed degradation or proportional to the velocity of the vehicle/mobile terminal. Such determination may be based on user settings, service provider settings, etc. If the degradation is to be fixed, then at block 214 audio and/or video output of the offending mobile terminal is degraded by a fixed amount (e.g., 30 percent degradation). If the degradation is to be varied with the speed of the vehicle/mobile terminal, then the audio and/or video is degraded in proportion to the speed of the vehicle/mobile terminal (e.g., as speed increases, degradation increases, and as speed decreases, degradation decreases). Once the audio and/or video is degraded, the method moves back to block 202 and repeats.

Moving now to FIG. 11, exemplary steps associated with receiving the notification are illustrated. Beginning at block 222, it is determined if a notification has been received by the terminal. If a notification has not been received, then the method moves to block 224 and communication may proceed as is conventional. However, if a notification is received, then at block 226 an output, such as an audio output, for example, is output so as to correspond to the velocity of the mobile terminal sending the notification (the specific form of the notification may be based on user preferences, manufacturer settings, service provider settings, etc. and may include a voice message, flashing lights, audio tone, audio/video degradation, etc.). If the output is not to vary with the velocity, then at block 228 the notification is output on the terminal, wherein the notification is fixed (i.e., it does not vary with velocity). However, if the output is to vary with velocity, then at block 230 the notification is output on the terminal, wherein a characteristic of the notification corresponds to velocity. For example, if the mobile terminal that originated the notification is traveling at 30 MPH and then increases in speed to 60 MPH, a notification embodied as an audio alert, for example, may be initially output at a first volume, and then the volume may be increased as velocity increases.

Next at block 232 it is determined if audio and/or video output (e.g., the speech and/or images of the respective communicating parties) will be degraded. Again, such settings can be based on user, manufacturer and/or service provider settings. If the audio and/or video will not be degraded, then the method moves back to block 222 and repeats. However, if the audio and/or video output will be degraded, then at block 234 it is determined if the audio and/or video will be degraded in proportion to velocity of the mobile terminal. If the degradation will not correspond to velocity, then at block 236 a fixed degradation is applied to the audio and/or video signal prior to output (e.g., an error may be inserted in every fifth frame of the audio and/or video data). If the degradation is to correspond to velocity, then at block 238 the degradation applied to the audio and/or video signal will correspond to velocity (e.g., as velocity increases/decreases, the number of errors inserted into the audio and/or video frames also increases/decreases, thereby degrading quality in proportion to velocity).

Next at block 240 it is determined if other aspects of the terminal will be altered based on the notification (e.g., vibration of the terminal, etc.). If physical aspects will not be altered, then the method moves back to block 222 and repeats. However, if physical aspects of the terminal will be altered, then at block 242 the terminal may vibrate, for example, during the period in which the motion is detected (e.g., a fixed vibration or proportional to velocity). The method then moves back to block 222 and repeats.

Accordingly, a device and method has been described that promotes safe operation of mobile terminals in moving vehicles. In particular, parties involved in a communication can be notified of user's who may be operating their mobile terminals in moving vehicles. Such notification can tend to discourage use of mobile terminals in moving vehicles.

It is noted that at least some of parties to the communication may be using a fixed or desk-top terminals (e.g., a land-line phone). Such fixed terminals may include the ability to receive and/or act on notifications provided by the mobile terminals and output such notifications to a user as described with respect to FIG. 11. For legacy terminals that may not have such functionality, the notification may be handled entirely by the mobile terminal and/or service provider. For example, the moving mobile terminal may encode a notification message along with the user's voice such that the legacy terminal need only output the audio signal (which will include the notification). A person having ordinary skill in the art of computer programming and applications of programming for communication terminals, such as mobile terminals and fixed terminals would be able in view of the description provided herein to program a to operate and to carry out the functions described herein. Accordingly, details as to the specific programming code have been omitted for the sake of brevity. Also, while software in the memory or in some other memory of the terminal may be used to allow the terminal to carry out the functions and features described herein in accordance with the preferred embodiment of the invention, such functions and features also could be carried out via dedicated hardware, firmware, software, or combinations thereof, without departing from the scope of the invention.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of operating electronic devices, comprising:
determining if a first electronic device is in communication with a second electronic device while said first electronic device is in a moving vehicle; and
providing a notification on said second electronic device corresponding to said determination.

2. The method according to claim 1, wherein providing the notification includes providing at least one of an audio message, a video message, or a text message.

3. The method according to claim 1, further comprising varying an intensity of the notification in proportion to a speed of the vehicle.

4. The method according to claim 1, further comprising:
determining a speed of the vehicle; and
including in said notification information indicative of said determined speed.

5. The method according to claim 1, wherein providing the notification includes causing the second electronic device to operate in a predetermined manner, vibrating the electronic device, emitting one or more flashes of light from the electronic device, emitting one or more sound pulses from the electronic device, rendering a predetermined voice message in combination with the communication, providing the notification only if it is determined the first electronic device is in a moving vehicle, degrading the quality of audio communicated between the first and second electronic devices, degrading the audio quality on only the first electronic device, or degrading the audio quality on only the second electronic device.

6. The method according to claim 5, wherein degrading the audio quality includes degrading the audio quality in proportion to a speed of the vehicle, conditioning the audio degradation based on whether the first electronic device is being used with a hands-free device, and/or providing a warning on each electronic device that the audio will be degraded prior to degrading the audio quality.

7. The method according to claim 1, wherein the communication comprises at least one of composing a text message, sending a text message, composing an e-mail message, sending an e-mail message, or sending voice data.

8. The method according to claim 1, further comprising determining if a user of the first electronic device is an operator or a non-operator of the moving vehicle, and providing the notification only when the user of the first electronic device is an operator of the moving vehicle.

9. The method according to claim 8, wherein determining if a user of the electronic device is an operator or a non-operator includes using a near field device to determine a location of the user in the vehicle.

10. The method according to claim 1, further comprising providing the notification to a communication service provider of the first electronic device.

11. An electronic device, comprising:
a communication circuit adapted to provide two-way communication between the electronic device and at least one other device;
a motion processing circuit adapted to determine if the electronic device is operated in a moving vehicle; and
a control circuit adapted to provide a notification to the at least one other device, said notification corresponding to the results of the determination.

12. The device according to claim 11, wherein the notification is at least one of an audio message, a video message, or a text message.

13. The device according to claim 11, wherein the control circuit is further adapted to vary an intensity of the notification in proportion to a speed of the vehicle.

14. The device according to claim 11, wherein the control circuit is further adapted to:
determine a speed of the vehicle; and
include in said notification information indicative of said determined speed.

15. The device according to claim 11, wherein the communication circuit is further adapted to receive a notification from the at least one other device, and the control circuit is further adapted to cause the electronic device to behave in a predetermined manner based on the notification, to vibrate, to emit one or more flashes of light, to emit one or more sound pulses, to use a predetermined voice message in combination with the communication as the notification, or to provide the notification only if it is determined that the electronic device is in a moving vehicle.

16. The device according to claim 11, wherein the communication includes at least one of composing a text message, sending a text message, composing an e-mail message, sending an e-mail message, or transmitting voice data.

17. The device according to claim 11, wherein the control circuit is further adapted to degrade the quality of audio received by or transmitted from the electronic device, to degrade the quality of the audio in proportion to a speed of the vehicle, to condition the audio quality degradation based on whether the electronic device is used with a hands-free device, and/or to provide a warning that the audio quality will be degraded prior to degrading the audio quality.

18. The device according to claim 11, wherein the control circuit is further adapted to determine if a user of the electronic device is an operator or a non-operator of the moving vehicle, and inhibit said notification if the user is a non-operator of the moving vehicle.

19. A method of operating electronic devices, comprising:
determining if a first electronic device is in communication with a second electronic device while said first electronic device is in a moving vehicle; and
degrading at least one of an audio signal or a video signal communicated between said first and second devices based on said determination.

20. The method according to claim 34, wherein degrading includes degrading the at least one audio and/or video signal on both the first and second electronic devices.
